(19) United States
(12) Patent Application Publication
(10) Pub. No.: US 2003/0094300 A1
(43) Pub. Date: May 22, 2003

(54) One piece electrical terminal lug with stacked barrels

(75) Inventor: Richard Ernest Robicheau, Manchester, NH (US)

Correspondence Address: HARRINGTON & SMITH, LLP, 4 RESEARCH DRIVE, SHELTON, CT, 06484-6212, US

(73) Assignee: Framatone Connectors, Inc.

(21) Appl. No.: 10/300,944

(22) Filed: Nov. 20, 2002

Related U.S. Application Data
(60) Provisional application No. 60/331,831, filed on Nov. 20, 2001.

(51) Int. Cl. H02G 3/18

(52) U.S. Cl. 174/59

(57) ABSTRACT

An electrical terminal lug having barrel style electrical contacts for securing an electrical conductor, and methods for forming the electrical terminal lug, are disclosed herein. The electrical terminal lug includes first and second frame sections that are prepared and clamped together prior to permanent joining of the tongue portion of each frame section. Once joined, access ways may be incorporated for connection of the terminal lug to an electrical connection.

### CROSS-REFERENCE TO RELATED APPLICATION

This application claims the benefit under 35 USC §119(e) of provisional patent application No. 60/331,831 filed Nov. 20, 2001 which is hereby incorporated by reference in its entirety.

### BACKGROUND OF THE INVENTION

1. Field of the Invention

The present invention relates to electrical terminal lugs and, more particularly, to a lug having a one-piece frame with stacked barrels.

2. Brief Description of Prior Developments

Various methods have been used to make connection of multiple conductors to a bus bar. Frequently, where additional connections to a bus bar have become desirable, modification of the bus bar has been required. Consider, for example, bus bars used to provide grounding connections in industrial environments. In such an environment, temporary equipment may be needed and require grounding to a crowded or full bus bar.

Various methods have been devised to address this need, however, these are typically unsatisfactory. Consider for example, the limitations of disconnecting ancillary equipment to make room for required equipment. Alternatively, one method involves anchoring one terminal lug on top of another terminal lug. In this case, the user is typically not assured of proper or adequate contact with the bus bar or between the terminal lugs.

Many industries are confronted by problems associated with these types of connections. For example, telephone system operators, electric generation facilities, and other sophisticated commercial electrical installations (such as metal working facilities) frequently have a need to make multiple electrical connections in a crowded connection system.

Therefore, what is needed is a terminal lug that provides efficient electrical contact and increased capacity at the point of connection, such as the one disclosed herein.

### SUMMARY OF THE INVENTION

In accordance with one method of the present invention, a method for forming an electrical terminal lug, a method is provided comprising a first frame section comprising a first barrel portion adapted for mating with a first conductor and a first tongue portion characterized by smooth top and bottom surfaces adapted for electrical contact; providing a second frame section comprising a second barrel portion adapted for mating with a second conductor and a second tongue portion characterized by at least a smooth bottom surface adapted for electrical contact; stacking the second tongue portion onto the first tongue portion; clamping the second and first tongue portions together to a predetermined value; and, permanently joining the first tongue portion and second tongue portion to each other to form the electrical terminal lug.

In accordance with one aspect of the present invention, an electrical terminal lug is provided comprising a first frame section and a second frame section. The first frame section comprises a first barrel portion adapted for receiving a first electrical conductor and a first tongue portion characterized by smooth top and bottom surfaces adapted for electrical contact. The second frame section comprises a second barrel portion adapted for receiving a second electrical conductor and a second tongue portion characterized by at least a smooth bottom surface adapted for electrical contact. The first frame section and the second frame section are permanently joined together at the top of the first tongue portion and the bottom of the second tongue portion to provide the electrical terminal lug.

### BRIEF DESCRIPTION OF THE DRAWINGS

The foregoing aspects and other features of the present invention are explained in the following description, taken in connection with the accompanying drawings, wherein:

FIG. 1 is a perspective view of an electrical terminal lug incorporating features of the present invention;

FIG. 2 is an exploded perspective view of a first frame section and a second frame section of the lug shown in FIG. 1;

FIG. 3 is a perspective view of the first frame section and the second frame section, where a barrel style electrical contact on the second frame section is angled away from the first frame section;

FIG. 4 is a perspective view of the terminal lug with opposing electrical contacts; and,

FIG. 5 is an illustration of an installed terminal lug.

### DETAILED DESCRIPTION OF THE PREFERRED EMBODIMENT

Although the present invention will be described with reference to the embodiments shown in the drawings, it should be understood that the present invention can be embodied in many alternate forms or embodiments. In addition, any suitable size, shape or type of elements or materials could be used.

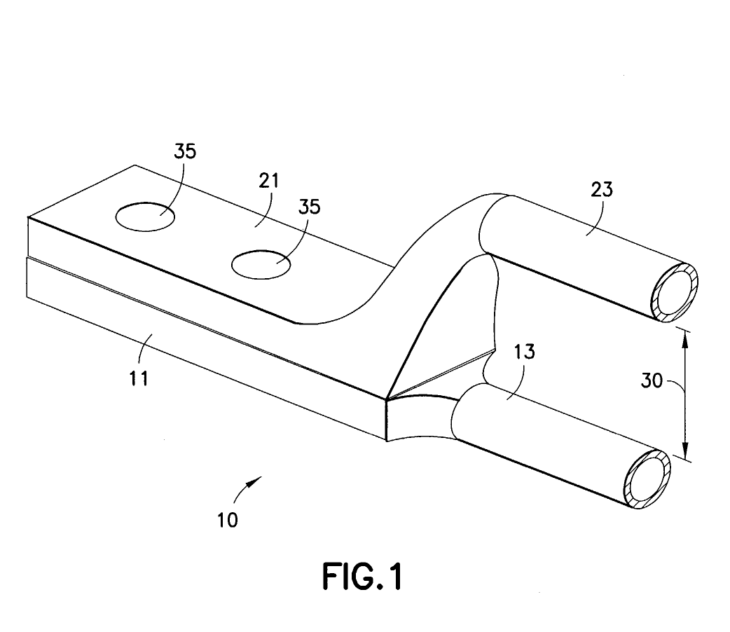

FIG. 1, provides a perspective view of an electrical terminal lug 10 incorporating features of the present invention. The terminal lug 10 generally comprises a first frame section 11, and a second frame section 21. The terminal lug 10 provides for connection of independent or separate electrical conductors to a single electrical contact. As typically used, the terminal lug 10 provides for connection to a bus bar, such as, but not limited to, a bus bar used for grounding of electrical equipment. The terminal lug 10 is connected by methods that may include, but are not limited to, bolting of the terminal lug 10 to the electrical connection through access ways 35. In the preferred embodiment, access ways 35, in the form of drilled holes, are provided through the first frame section 11 and the second frame section 21. The terminal lug 10 is connected to electrical conductors through use of integrated barrel type contacts 13, 23. In a preferred embodiment, the barrels 13, 23 are substantially vertically aligned together while also being vertically separated by a suitable gap 30. The gap 30 provides for separation room between the barrels 13, 23, which is required for appropriately attaching the separate electrical conductors. The first frame section 11 and the second frame section 21 are permanently joined or connected to each other before installation as a terminal lug 10.

The terminal lug 10 may be formed of any suitable material, or combination of materials, that provides for adequate conductivity of required or anticipated electrical load, and provides for required physical strength. For example, metals such as aluminum, copper or alloys such as steel may be used. The terminal lug 10 may be plated or otherwise coated as appropriate. The terminal lug 10 may be sized according to a variety of requirements, including, but not limited to, electrical load, conductor size, and available connection room.

The terminal lug 10 as disclosed herein provides certain advantages over competitive connection systems. Examples of advantages of the terminal lug 10 include, and are not limited to, increased capacity of a connection terminal (such as a bus bar), and reductions in labor and/or time necessary to complete the installation of a single connection.

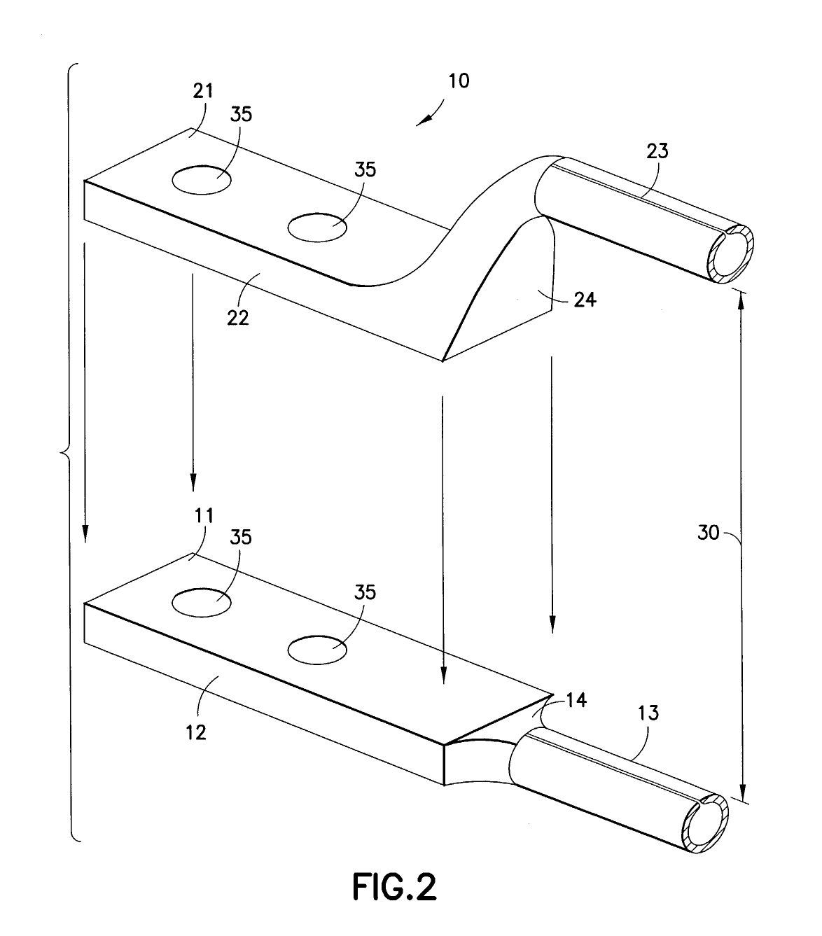

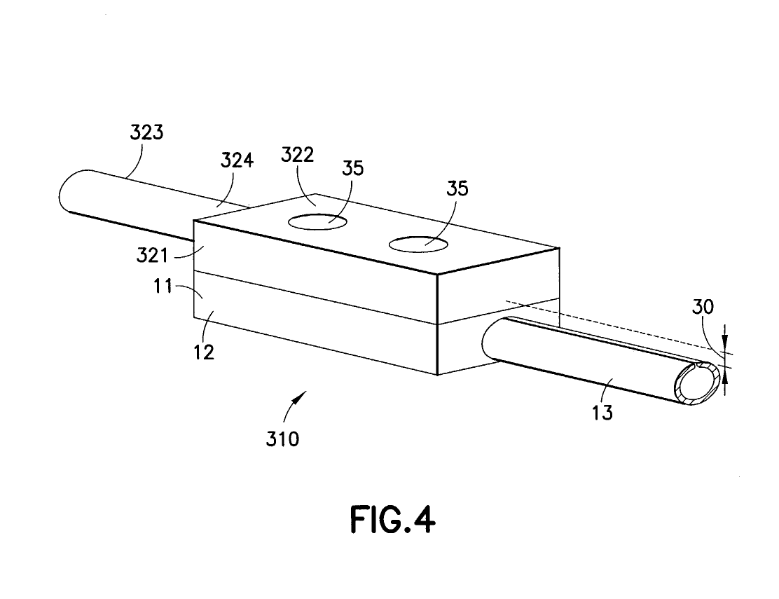

Although generally discussed herein in terms of the preferred embodiment shown in FIG. 1 and FIG. 2, the appearance or structure of the terminal lug 10 may deviate from this embodiment, while remaining within the teaching disclosed herein. For example, the electrical connections may be opposite to one another, such that the electrical connections travel from a bus bar in opposite directions, as shown in FIG. 4. As another example, the terminal lug 10 may include an interlocking design. In this embodiment, the sides of the first frame section 11 and the second frame section 21 may be characterized by lateral features such as jags or “teeth” that provide for at least a robust physical relationship with other terminal lugs 10 aligned in an array.

FIG. 2 provides a detailed perspective view of the first frame section 11, and the second frame section 21, where separate elements are illustrated.

In FIG. 2, the first frame section 11 includes a tongue portion 12 and an integrated barrel portion 13, connected together by an extension portion 14. The first tongue portion 12 is characterized by having electrical contact surfaces on two sides. That is, the bottom portion of the first tongue portion 12 provides an electrical contact with an electrical connection, such as a bus bar. The second electrical contact surface of the first tongue portion 12 is on the top of the tongue portion 12, and provides an electrical contact with the second tongue portion 22. The second frame section 21 includes the second tongue portion 22 and an integrated barrel portion 23, which are connected together by an extension portion 24. The bottom of the second tongue portion 22 provides a third electrical contact, which provides for electrical contact with the top of the first tongue portion 12. As indicated by the downward arrows in FIG. 2, the second frame section 21 overlies the first frame section 11, to provide for the terminal lug 10, shown in FIG. 1.

Each barrel portion 13, 23 provides for robust electrical connection to a separate electrical conductor (not shown). In the preferred embodiment, the electrical conductor is inserted into the barrel portion 13, 23. The barrel portion 13, 23 is then crimped or otherwise secured over the electrical conductor. The barrel portion 13, 23 is capable of securing a single electrical conductor or multiple electrical conductors. Connection of the barrel portion 13, 23 to the respective electrical conductors is completed through automated or manual methods, with the specific method chosen requiring certain clearance, as provided for by the gap 30, for effective completion. In the preferred embodiment, the barrels are substantially in alignment with each other.

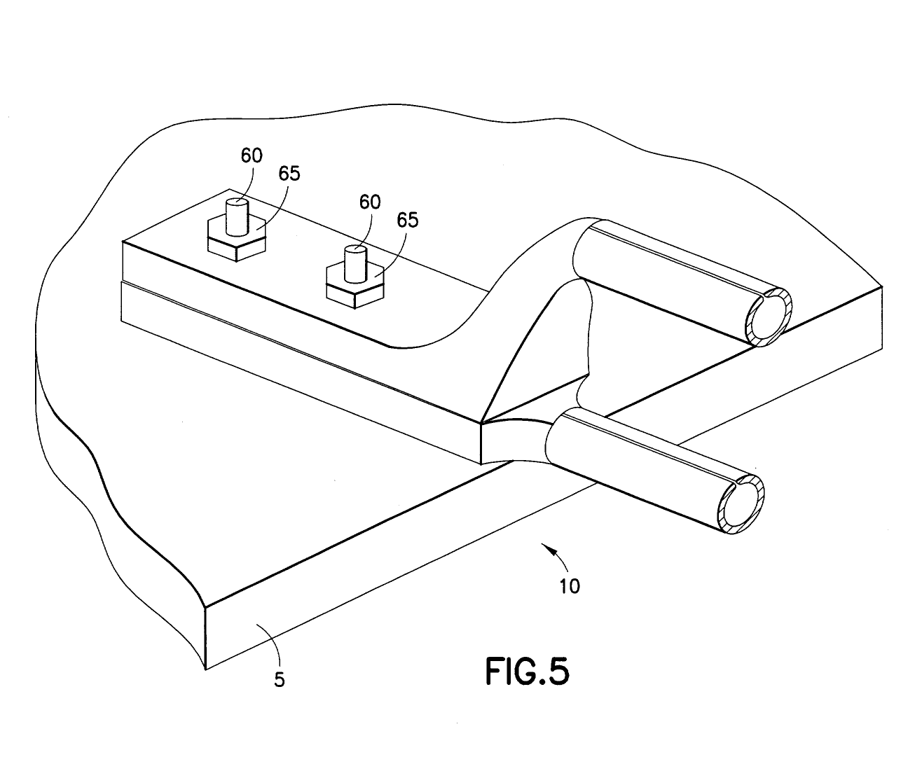

The tongue portion 12, 22 provides a robust connection to an electrical connection, such as, but not limited to, a bus bar. In the preferred embodiment, shown in FIG. 5, the tongue portion 12, 22 is anchored to the electrical connection 5 by placing the tongue 12, 22 over the electrical connection 5, wherein bolts 60 integrated into the electrical connection 5 are inserted through the access ways 35. The bottom tongue portion 12, also considered the base of bottom of the terminal lug 10, is rested over and in electrical contact with the electrical connection 5. The terminal lug 10 is secured in place with washers and nuts 65 attached to the bolt 60.

The one piece stacking terminal lug 10 is formed by the joining of the first frame section 11 and the second frame section 21. The first and second frame sections are at least examined or otherwise qualified to ensure smooth surface and regular appearance of the contact portions of the tongues 12 and 22. That is, the top and bottom of the first tongue 12 (first and second electrical contacts), and at least the bottom of the second tongue 22 (third electrical contact) have smooth surfaces with a regular appearance. Once the first and second tongues 12, 22 have been selected, the first and second tongues 12, 22 are clamped together at a predetermined pressure, torque or other value for the recommended hardware installation. The clamping further ensures the second and third contact surfaces between the tongues 12, 22 meet or exceed the number of contacting points needed for the anticipated current flow, and thus provide for a substantially flawless electrical interface. Once appropriate clamping requirements have been addressed, the first tongue 12 and the second tongue 22 are joined together, by welding, or soldering, or by any other suitable technique. In the preferred embodiment, the second and third electrical contact surfaces are joined by brazing.

Brazing the first tongue 12 and the second tongue 22 together is completed using known techniques for brazing. In one embodiment, the first tongue 12 and the second tongue 22 are brazed together along the sides and at the end that is opposite to the barrel contact 13, 23. After brazing is completed, the remnants of the brazing are removed through grinding or other suitable methods to ensure burrs are removed and smooth surfaces are achieved without the presence of corona.

Once the first tongue 12 and the second tongue 22 have been joined together, and before or after removal of the remnants, access ways 35 are drilled, punched, or otherwise placed into the terminal lug 10. The addition of access ways 35 after the joining of the first tongue 12 and the second tongue 22 ensures complete alignment of the access ways 35 through each tongue 12, 22. In the preferred embodiment, access ways 35 are drilled into the terminal lug 10, and then finishing is completed to remove brazing and drilling remnants.

In another embodiment, the one piece stacking terminal lug 10 is formed using techniques for casting, such as hot flow. In this embodiment, the first frame section 11 and the second frame section 21 are formed as one. In some embodiments, the casting is adapted for subsequent incorporation of a separate first barrel portion 13 and/or a separate second barrel portion 23. In the embodiments where the barrel portions 13, 23 are subsequently incorporated with the casting, the barrel portions 13, 23 may be attached using brazing or other similar techniques. Where the barrel portions 13, 23 are subsequently attached to the frame sections 11, 21, the barrel portions 13, 23 may be formed of materials other than those used in the frame sections 11, 21. The one piece stacking terminal lug 10 may then be finished using techniques such as those of the next embodiment.

In another embodiment involving the casting of the one piece stacking terminal lug 10, the entire lug 10 is formed in the casting process. Finishing steps may include, without limitation: drilling or otherwise preparing the barrel portions 13, 23 for receipt of the electrical conductor; drilling or otherwise incorporating the access ways 35; and, removal of casting artifacts.

Additional Embodiments

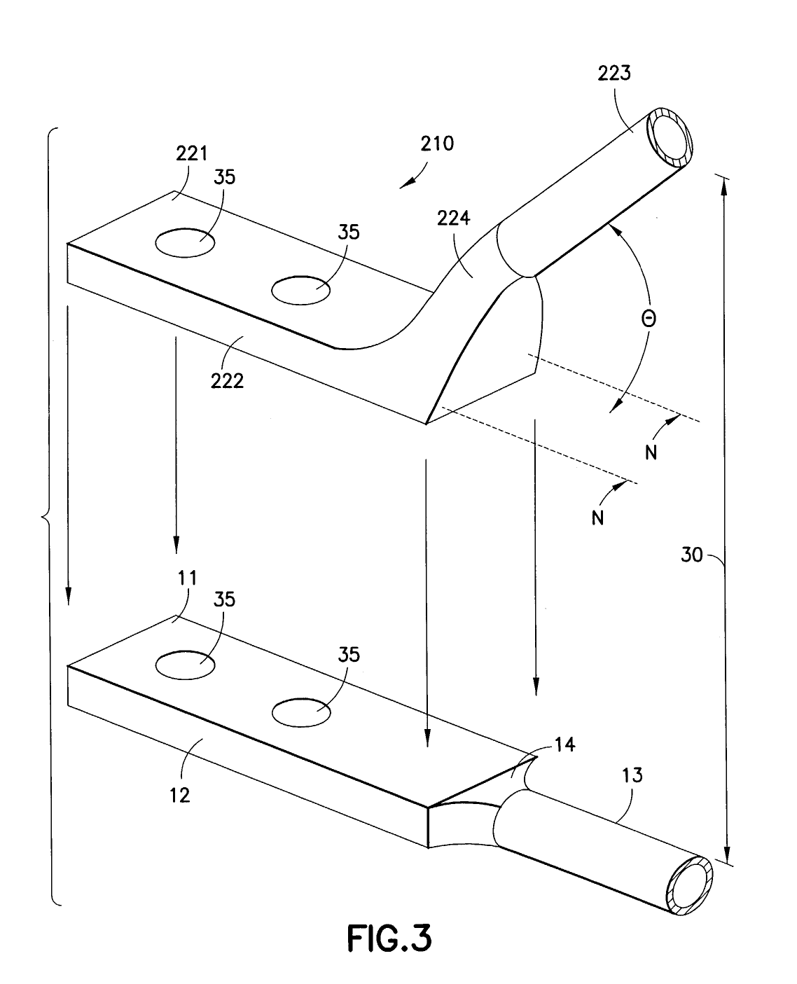

In the preferred embodiment, shown in FIG. 1 and FIG. 2, the first barrel portion 13 and the second barrel portion 23 are aligned to each other, and separated by a gap 30. The gap 30 allows each barrel 13, 23 to be independently crimped or otherwise set onto a corresponding conductor. In various embodiments, the barrel portions 13, 23 are separated by a gap 30 that is constant over the length of the barrel 13, 23 (that is, the barrels 13, 23 are parallel). In other embodiments, the gap 30 increases moving outward from the tongue over the length of the barrel. FIG. 3 provides an illustration of one version of these embodiments, where the electrical terminal lug 210 incoporates modifications to the second frame section 221. In FIG. 3, the second barrel 223 is set at an angle theta (θ) from a plane (N) that travels horizontally through the second tongue portion 222 of the second frame section 221 by use of a modified extension portion 224. Accordingly, in other embodiments, the first barrel 13 may also be offset at an angle from a plane that travels horizontally through the first tongue portion 12.

In various embodiments, the first barrel 13 and the second barrel 23 are not vertically aligned with each other. For example, as shown in FIG. 4, the second barrel 323 may be connected 180° from the first barrel 13. In this embodiment, the height of the gap 30 is a minimum. However, as the second barrel 323 is substantially offset, slightly offset, or otherwise oriented so as not to be in vertical alignment with the first barrel 13, the clearance provided by the gap 30 is not required for providing room necessary for effective securing of the electrical conductor into the barrel contact 13, 23. Other aspects of the second frame section 321, such as the appearance of the extension portion 324 and the form of the second tongue section 322 may be modified as appropriate to meet the needs of the user.

It should be understood that the foregoing description is only illustrative of the invention. Various alternatives and modifications can be devised by those skilled in the art without departing from the invention. As numerous applications exist for the terminal lug 10, 210, 310 disclosed herein, it is anticipated that the further embodiments than those described herein will develop. For example, a third frame section could be incorporated over the second frame section. Accordingly, the present invention is intended to embrace all such alternatives, modifications and variations which fall within the scope of the appended claims.

What is claimed is:

1. A method for forming an electrical terminal lug, the method comprising:
providing a first frame section comprising a first barrel portion adapted for mating with a first conductor and a first tongue portion characterized by smooth top and bottom surfaces adapted for electrical contact;
providing a second frame section comprising a second barrel portion adapted for mating with a second conductor and a second tongue portion characterized by at least a smooth bottom surface adapted for electrical contact;
stacking the second tongue portion onto the first tongue portion;
clamping the second and first tongue portions together to a predetermined value; and,
permanently joining the first tongue portion and second tongue portion to each other to form the electrical terminal lug.

2. The method in claim 1, wherein joining comprises at least one of brazing, welding and soldering.

3. The method in claim 1, further comprising forming at least one access way through the first tongue portion and the second tongue portion.

4. The method in claim 3, wherein the forming comprises at least one of drilling and punching.

5. An electrical terminal lug, comprising:
a first frame section comprising a first barrel portion adapted for receiving a first electrical conductor and a first tongue portion characterized by smooth top and bottom surfaces adapted for electrical contact; and
a second frame section comprising a second barrel portion adapted for receiving a second electrical conductor and a second tongue portion characterized by at least a smooth bottom surface adapted for electrical contact;
wherein the first frame section and the second frame section being permanently joined together at the top of the first tongue portion and the bottom of the second tongue portion to provide the electrical terminal lug.

6. The electrical terminal lug of claim 5, further comprising at least one access way through the first tongue portion and the second tongue portion wherein said access way is adapted for insertion of at least one anchoring bolt of an electrical terminal.

7. The electrical terminal lug of claim 5, comprising the first barrel portion in substantially in alignment with the second barrel portion.

8. The electrical terminal lug of claim 5, comprising the first barrel portion oriented so as not to be in alignment with the second barrel portion.

9. The electrical terminal lug of claim 5, comprising at least one barrel portion set at an angle from a respective tongue portion.

10. The electrical terminal lug of claim 5, comprising at least one tongue portion comprising lateral features.
